(19) United States
(12) Patent Application Publication
(10) Pub. No.: US 2003/0072602 A1
(43) Pub. Date: Apr. 17, 2003

(54) Device comprising magnetizable particles

(75) Inventor: Jean-Louis H. Gueret, Paris (FR)

Correspondence Address: Thomas L. Irving, FINNEGAN, HENDERSON, FARABOW,, GARRETT & DUNNER, L.L.P., 1300 I Street, N.W., Washington, DC, 20005-3315, US

(73) Assignee: L'OREAL

(21) Appl. No.: 10/121,603

(22) Filed: Apr. 15, 2002

(30) Foreign Application Priority Data
Apr. 13, 2001 (FR) 01 05110

(51) Int. Cl. B43K 5/00

(52) U.S. Cl. 401/261

(57) ABSTRACT

A device includes a receptacle, a substance contained in the receptacle, and a plurality of particles contained in the receptacle. The plurality of particles may include at least one of magnetizable particles mixed with the substance and magnetizable particles coated with the substance. The device may also include a limiter element configured to limit egress, from a portion of the device, of at least a portion of at least one of the substance and the at least one of magnetizable particles mixed with the substance and magnetizable particles coated with the substance. In addition, the device may be provided with at least one of a magnetic element and a magnetizable element configured to generate a magnetic field for interacting with the particles in the receptacle.

The present invention relates to a device that may be associated with applying a product, for example, applying a make-up or a care-product to the skin, to the hair, to the eyelashes, to the finger nails, and/or to the toe nails. The device may include a receptacle containing at least one substance, and a limiter element, for example, suitable for limiting extraction of at least a portion of the substance from the receptacle.

Boxes are known that may house a receptacle in the form of a cup filled with powder, a screen, and a powder puff for taking the substance from the screen and applying it to the surface. The cup may have a soft bottom so as to make it possible to apply pressure to the substance, thereby bringing the substance to the screen. Such pressure may result, however, in causing the substance to blow away and/or make a mess.

Powder-containing receptacles are also known, which have an opening provided with a block of foam, the powder being extracted by means of an applicator which is inserted into the receptacle through the block of foam.

It may be of interest to improve the ease with which a substance may be extracted with such devices, and to improve the ease with which a substance can be extracted after it has accumulated in the bottom of the device. It may also be of interest to reduce the risk of the substance exiting the box in an uncontrolled fashion when, for example, the box is opened and/or while substance is being extracted for application purposes.

In the following description, certain aspects will become evident. It should be understood that the invention, in its broadest sense, could be practiced without having one or more of these aspects.

In one aspect, as embodied and broadly described herein, the invention includes a device including a receptacle, a substance contained in the receptacle, and a plurality of particles contained in the receptacle. The plurality of particles may include at least one of magnetizable particles mixed with the substance and magnetizable particles coated with the substance. The device may further include a limiter element configured to limit egress, from a portion of the device, of at least a portion of at least one of the substance and the at least one of magnetizable particles mixed with the substance and magnetizable particles coated with the substance. The device may also be provided with at least one of a magnetic element and a magnetizable element configured to generate a magnetic field for interacting with the particles in the receptacle.

As used herein, the term “magnetizable particles” means any particles that may be sensitive to the action of a magnetic field. For example, “magnetizable particles” may be particles that are attracted to and/or repelled from a magnetic field. Such particles need not present any residual or permanent magnetization. Alternatively, they may present such magnetization.

The magnetic fields may be generated in such a manner as to, for example, encourage transport of the substance towards and/or through the limiter element. Under such circumstances, the substance to be applied (e.g., to the user) is optionally not sensitive to the action of a magnetic field and may merely be mixed with magnetizable particles. The movement of the magnetizable particles under the effect of the magnetic field may be used to transport the substance in the desired manner. Alternatively, the substance itself may present magnetic properties.

In addition, or according to another aspect, the magnetic field may be generated so as to encourage retention of the substance on a portion of the device, thus preventing the substance from blowing out of or running away from (depending on the nature of the substance) the device during application and/or while the receptacle is being opened, for example. Under such circumstances, the substance (e.g., for application) may be sensitive to the action of a magnetic field and may incorporate magnetizable particles. The particles may be magnetic micro-particles dispersed within the substance and intimately bonded thereto. Alternatively, the particles may be grains of a magnetizable material that are coated with the substance. The use of a magnetic and/or magnetizable applicator element and a substance that is sensitive to the action of the magnetic field of the applicator element may encourage retention of the substance on the applicator element while the applicator element is being moved from the receptacle towards a surface to be treated. This may reduce the risk of the substance blowing and/or dripping away.

The magnetic field may be generated by, for example, a magnetic applicator element or a removable magnet that may be moved into position, for example, during transport and that may be removed at the time of use.

In yet another aspect, the limiter element may be configured such that it is permeable to the substance. The limiter element may include at least one member chosen from a screen member, a perforated wall member, a porous member (e.g., a foam member), a sintered member, a felt member, a non-woven cloth member, a woven cloth member, and a brush member. Further, the limiter element may include a superposition of at least two members. For example, the limiter element may include a perforated wall lined with at least one of the porous member and the screen member.

In some embodiments, the limiter element is configured to limit egress of at least some of the substance and/or particles from at least part of the interior of the receptacle. Other configurations are also possible.

In another aspect, the device may be provided with an applicator element. The applicator element may or may not be distinct from the limiter element. In addition, the applicator element may include at least one of a magnetic element and a magnetizable element. Further, the applicator element may include at least one of an additional magnetic element and an additional magnetizable element, substantially distinct from any other magnetic and/or magnetizable elements of the device. The applicator element may house a substantially solid magnet and/or a flexible magnet. In addition, the applicator element may include at least one of dispersed magnetic particles and dispersed magnetizable particles.

Magnet(s) and/or magnetizable particles of the applicator element may be situated so as to cause the substance to be selectively loaded onto predetermined regions of the applicator element. For example, a centrally located magnet may encourage a more centrally located distribution of the substance on the applicator element.

According to yet another aspect, the device may include a handle element connected to, for example, the applicator element. In addition, the handle element may be configured to substantially close the receptacle. The applicator element may also house a magnet and the magnet may be connected to the handle element.

In still another aspect, the limiter element may be at least one of a magnetic element and a magnetizable element. The limiter element may include at least one of an additional magnetic element and an additional magnetizable element, substantially distinct from any other magnetic and/or magnetizable elements of the device. In addition, according to another aspect, the device may include a limiter element and an applicator element, wherein limiter element may be at least one of magnetic and magnetizable, and the applicator element may be substantially non-magnetic and/or non-magnetizable. The limiter element may include a substantially planar screen and the applicator element may include a powder puff. In addition, the limiter element may include a substantially concave surface facing the applicator element. Alternatively, the limiter element may include a substantially finger-shaped element. Further, the limiter element may include a porous element (e.g., a foam element).

In a further aspect, at least a portion of the limiter element may include an applicator element. The applicator element may be connected to the receptacle. For example, the applicator element may be connected to the receptacle so as to substantially preclude disconnection therefrom (e.g., the applicator element may be permanently mounted on the receptacle).

In an additional aspect, the device may include a closure member for closing the receptacle. The closure member may include at least one of a magnetic element and a magnetizable element. The closure member may include at least one of an additional magnetic element and an additional magnetizable element, substantially distinct from any other magnetic and/or magnetizable elements of the device.

In another aspect, the limiter element may include a rotary element. For example, the limiter element may include an outside zone configured to apply the substance and an inside zone configured to be loaded with the substance.

In yet another aspect, the limiter element may be configured to transfer the substance from the receptacle to the applicator element, and the limiter element may include at least one of a magnetic element and a magnetizable element. For example, the limiter element may be arranged in such a manner so as to transport the substance from the receptacle to the applicator element while it is turning (e.g., when the limiter element includes a rotary element). The limiter element may include at least one of an additional magnetic element and an additional magnetizable element, substantially distinct from any other magnetic and/or magnetizable elements of the device.

In a further aspect, the applicator element may include, for example, at least one of a porous element (e.g., a foam element), a sintered element, a felt element, a non-woven cloth element, bristles, a woven cloth element, and flocking, and/or any other suitable material and/or composition.

In yet another aspect, the device may include at least one removable magnet configured to generate a magnetic field that may oppose egress of at least some of the particles from the receptacle. The at least one magnetic and/or magnetizable element of the device may include the at least one removable magnet. Alternatively, the at least one magnetic element and/or magnetizable element of the device does not include the removable magnet. In addition, the magnetic field that opposes egress of at least some of the particles from the receptacle may be stronger than the magnetic field for interacting with the particles in the receptacle. In one aspect, the receptacle may include a bottom wall having an outside face and the removable magnet may be configured to be fixed on the outside face. For example, the device may include a removable magnet suitable, in a storage position, for generating a magnetic field that opposes extraction of magnetizable particles from the receptacle. The removable magnet may include the only magnetic element suitable for generating the magnetic field that acts on the distribution of the magnetizable particles in the receptacle. The device may also include a removable magnet that may be distinct from the magnetic element suitable for generating said magnetic field for acting on the distribution of magnetizable particles inside the receptacle.

In another aspect, at least a portion of the particles may include magnetizable particles coated with at least one of a cosmetic product and/or a care product. In addition or alternatively, the device may contain magnetizable particles mixed with the substance.

In still another aspect, the limiter element may include at least one passage defining a dimension configured to enable egress of the substance from the receptacle, while being configured to substantially prevent egress of the magnetizable particles from the receptacle. The substance may include a binder configured to encourage the substance to adhere to the magnetizable particles. Further, at least a portion of the magnetizable particles may include substantially non-magnetic bodies having grains of magnetizable material fixed on the surface of the substantially non-magnetic bodies. The non-magnetic bodies may be chosen from, for example, at least one of fibers, wood fibers, beads, and hollow glass beads, and/or any other suitable material and/or composition.

According to an additional aspect, at least a portion of the substance may include, for example, a powder and/or a liquid. The substance may be, for example, a face powder, a blusher, an eye shadow, an eye-contour shadow, a component of a kohl pencil, or an eyeliner component. The substance may also be, for example, a ferrofluid and/or an emulsion containing a ferrofluid.

In another aspect, the receptacle may include substantially rigid bottom and/or side walls. For example, the substance may be contained in a receptacle that is substantially not deformable (e.g., a receptacle presenting rigid side walls and a rigid bottom) so that the substance may be extracted without compressing the receptacle.

In yet another aspect, the substance may include at least one of a cosmetic product and/or a care product. For example, the substance may include a make-up product. Further, the device may include an applicator element configured to apply at least the substance.

In an additional aspect, a method of applying a product may include providing a device, loading the applicator element with at least the substance, and placing the applicator element in contact with at least one of skin, hair, a finger nail, a toe nail, eye lashes, and eye brows so as to apply at least the substance thereto.

The term “providing” is used in a broad sense, and refers to, but is not limited to, making available for use, enabling usage, giving, supplying, obtaining, getting a hold of, acquiring, purchasing, selling, distributing, possessing, making ready for use, and/or placing in a position ready for use.

In another aspect, there is a method of loading an applicator element with at least substance. The method includes moving at least a portion of the substance toward the applicator element with at least one of a magnetic element and a magnetizable element so as to encourage loading of the applicator element with substance.

In another aspect, a method for loading an applicator element with at least substance includes moving the substance via a magnetic field in order to encourage the applicator element to be loaded with at least the substance. In some cases, for example, the substance may be extracted without shaking the receptacle.

According to another aspect, a device may include a receptacle, a substance contained in the receptacle, and a plurality of particles contained in the receptacle. The plurality of particles may include at least one of magnetizable particles mixed with the substance and magnetizable particles coated with the substance. The device may also include an applicator element configured to attract at least a portion of one of the magnetizable particles mixed with the substance and the magnetizable particles coated with the substance. The applicator element may include at least one of a magnetic element and a magnetizable element configured to attract at least a portion of the particles in the receptacle. In addition, the device may include a limiter element configured to limit egress, from a portion of the device, of at least a portion of at least one of the substance and said at least one of magnetizable particles mixed with the substance and magnetizable particles coated with the substance.

Aside from the structural and procedural arrangements set forth above, the invention could include a number of other arrangements, such as those explained hereinafter. It is to be understood, that both the foregoing description and the following description are exemplary.

The accompanying drawings are incorporated in and constitute a part of this specification. The drawings illustrate exemplary embodiments of the invention and, together with the description, serve to explain some principles of the invention. In the drawings,

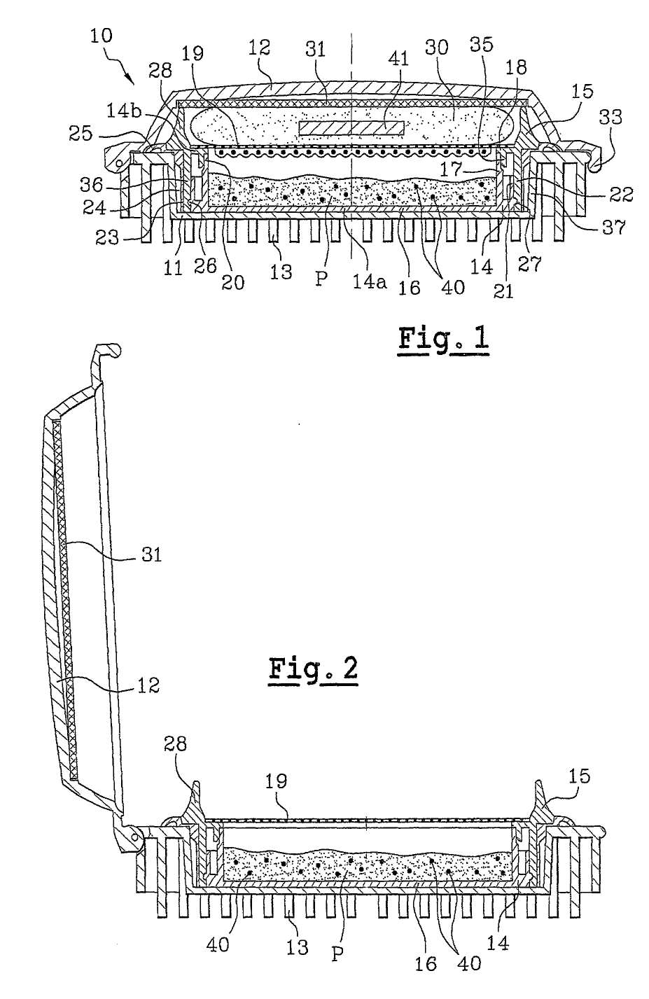

FIG. 1 is a schematic axial cross-section view of an embodiment of a device according to one aspect of the invention;

FIG. 2 is a view of the embodiment shown in FIG. 1 in an alternative configuration;

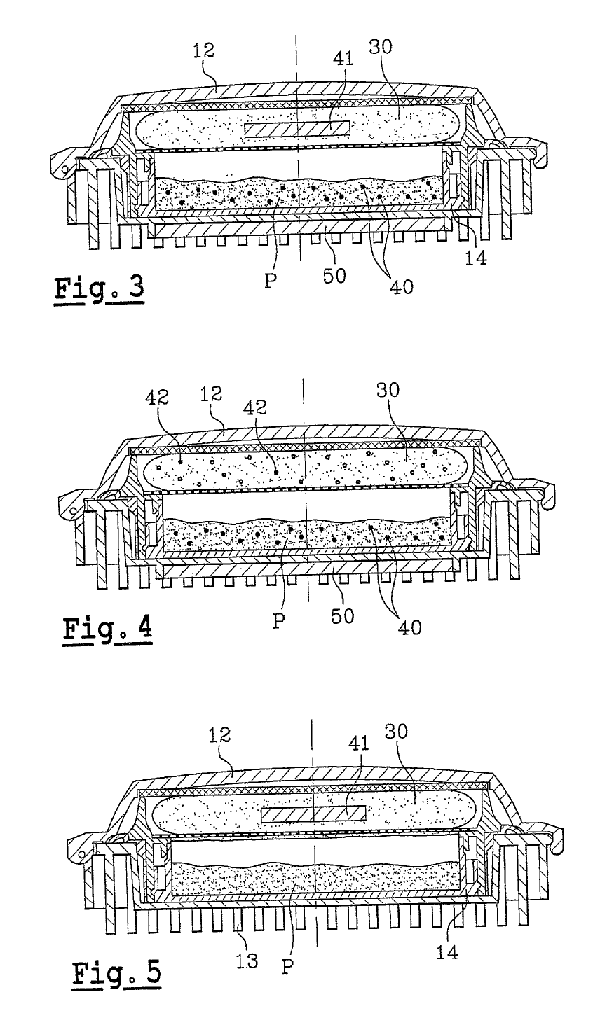

FIG. 3 is a schematic axial cross-section view of another embodiment of a device;

FIG. 4 is a schematic axial cross-section view of a further embodiment of a device;

FIG. 5 is a schematic axial cross-section view of an additional embodiment of a device;

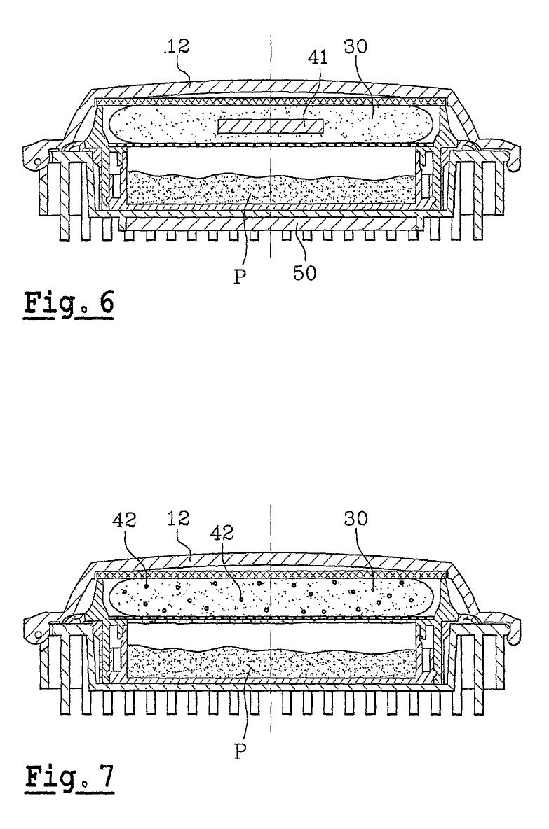

FIG. 6 is a schematic axial cross-section view of another embodiment of a device;

FIG. 7 is a schematic axial cross-section view of a further embodiment of a device;

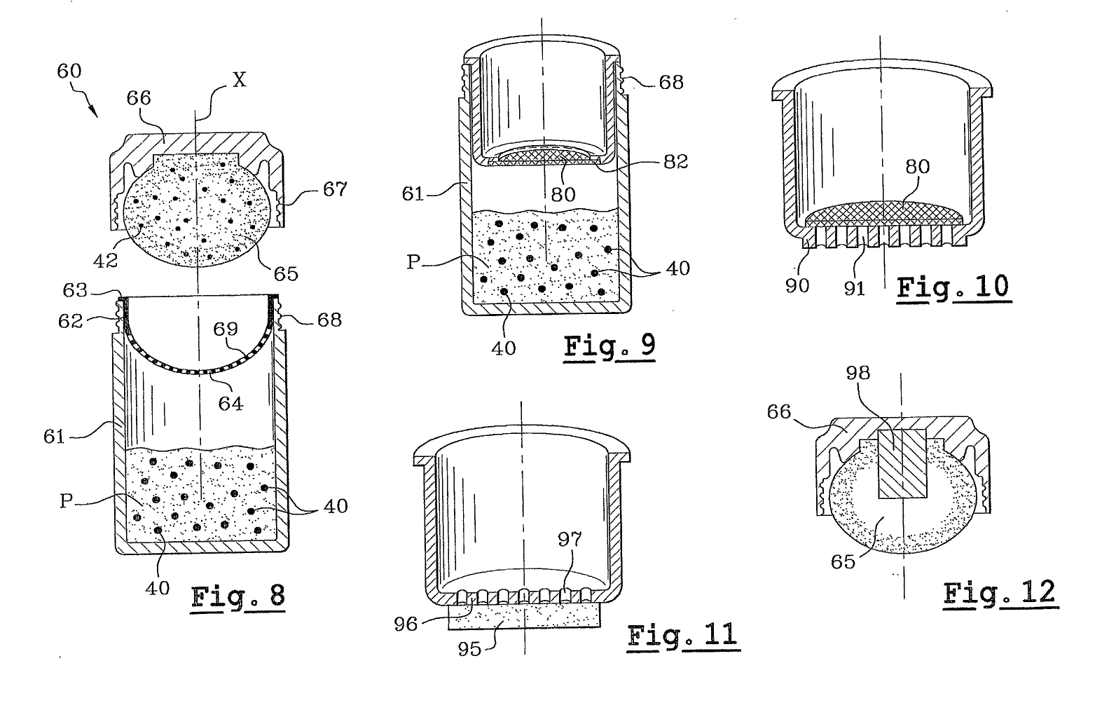

FIG. 8 is a schematic axial cross-section view of another embodiment of a device;

FIG. 9 is a schematic axial cross-section view of a further embodiment of a device;

FIG. 10 is a schematic axial cross-section view of an alternative portion of a device;

FIG. 11 is a schematic axial cross-section view of another alternative portion of a device;

FIG. 12 is a schematic axial cross-section view of an alternative applicator for a device;

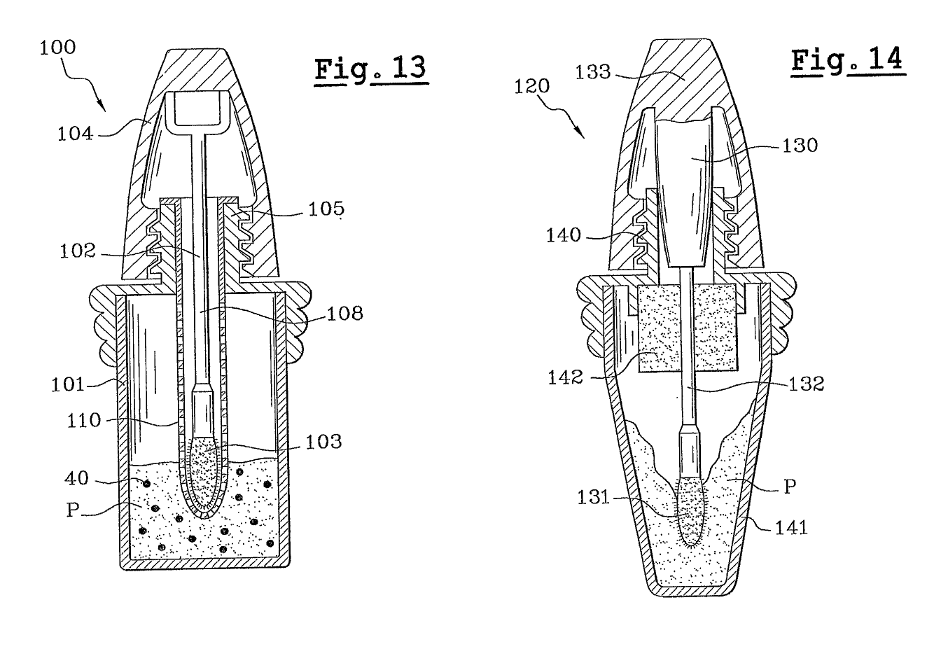

FIG. 13 is a schematic axial cross-section view of another embodiment of a device;

FIG. 14 is a schematic axial cross-section view of another embodiment of a device;

FIG. 15 is a schematic axial cross-section view of a further embodiment of a device;

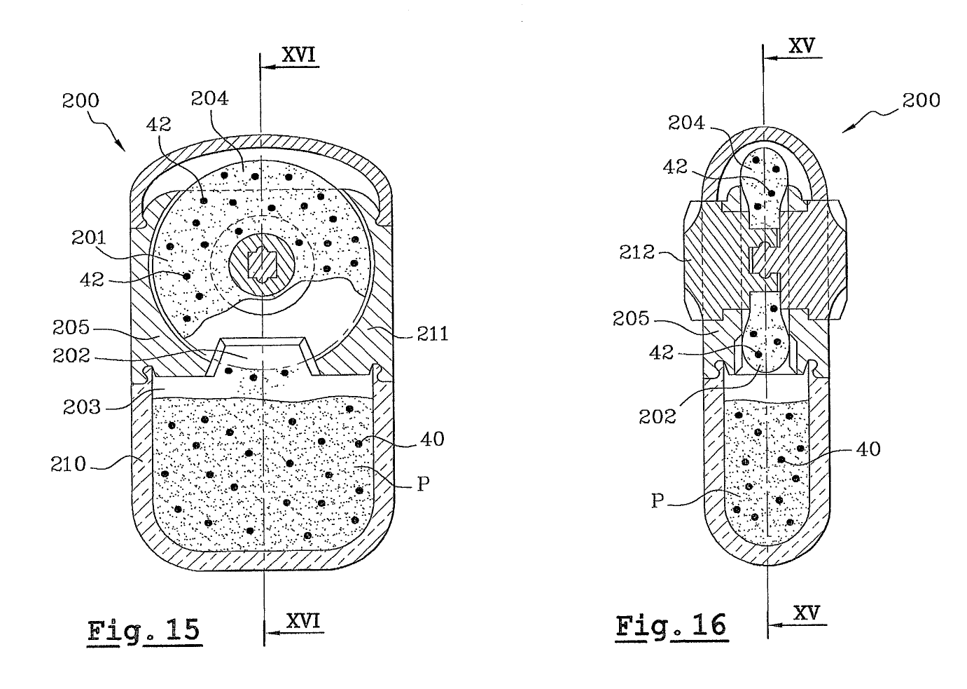

FIG. 16 is a schematic cross-section view taken along plane XVI-XVI of FIG. 15;

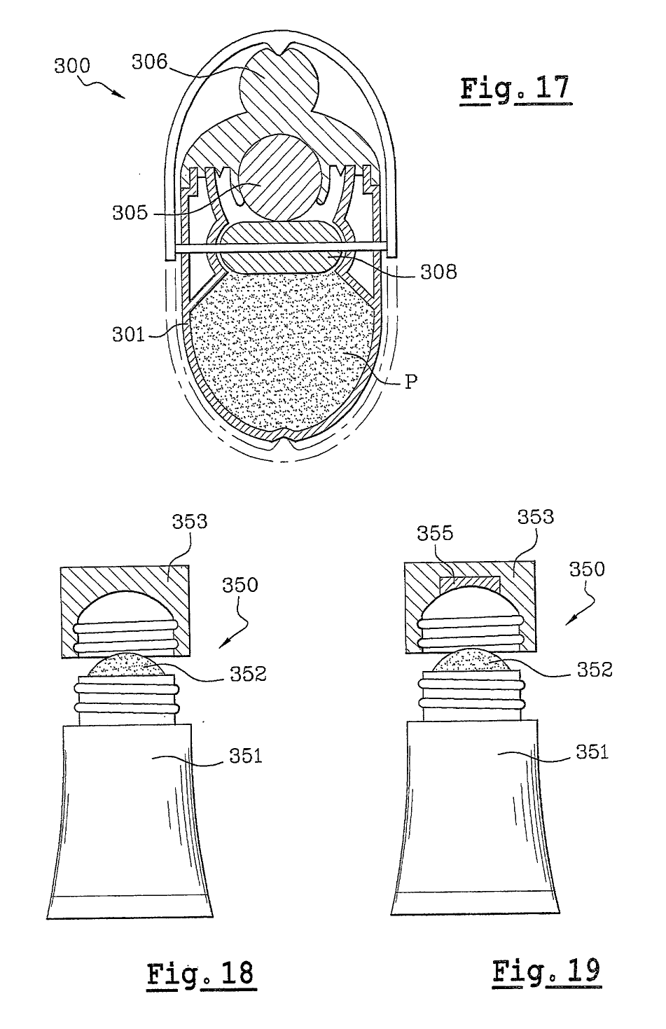

FIG. 17 is a schematic axial cross-section view of a further embodiment of a device;

FIG. 18 is a schematic partial cross-section view of another embodiment of a device;

FIG. 19 is a schematic partial cross-section view of a further embodiment of a device;

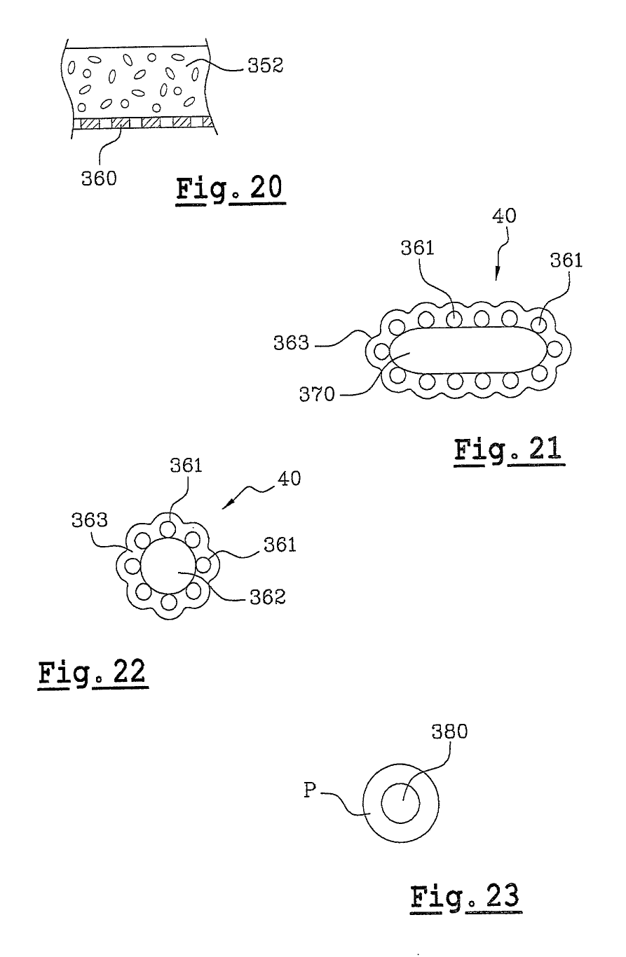

FIG. 20 is a partial schematic cross-section view of an embodiment of a porous member;

FIG. 21 is a schematic cross-section view of an embodiment of a magnetizable particle;

FIG. 22 is a schematic cross-section view of another embodiment of a magnetizable particle; and

FIG. 23 is schematic view of an embodiment of a particle of substance.

Reference will now be made in detail to some possible embodiments of the invention, examples of which are illustrated in the accompanying drawings. Wherever possible, the same reference numbers are used in the drawings and the description to refer to the same or like parts.

FIG. 1 is a schematic axial cross-section view of a device 10 (e.g., a device for applying a cosmetic product and/or a care product), for example, a make-up box, that may include a body 11 and a lid 12 hinged to the body 11. The body 11 may be provided with ribs 13 on the outside (e.g., for enhancing the appearance of the device 10). The inside of the device 10, may house a cup 14 made, for example, by assembling a lower element 14a to an upper element 14b.

The cup 14 may contain a substance P for applying to a surface that is to be made up. The cup 14 may include a receptacle. The lower element 14a may be provided with a bottom wall 16 and a side wall 17 (e.g., a cylindrical side wall) surrounded by a rib 21. The upper element 14b may include a wall 15 (e.g., an annular wall) which defines a housing for receiving, for example, a powder puff 30. The wall 15 may be extended downwards by a skirt 22, for example, a cylindrical skirt, which may snap-fasten on a bead 27 formed at the base of the rib 21 on its outer side. The upper element 14b may also include a rim 18, which bears against the top edge of the side wall 20. A rib 35 may extend the rim 18 downwards and may press against the side wall 28 on its outer side. The rim 18 may support a screen 19, which may be fixed thereto, for example, by heat-sealing and/or by adhesive.

The outside of the skirt 22 may be surrounded by a gasket 23 (e.g., an elastomer gasket) including a skirt 36 that may be provided with axial ribs 24 distributed around its periphery, and that may engage, for example, by friction, against the wall 37 of the housing in the body 11 that receives the cup 14. The top portion of the gasket 23 may include an annular portion 25 against which the lid 12 may come to bear to isolate the substance P contained inside the cup 14 in a substantially leak-tight manner from the outside when the device 10 is closed. The lid 12 may include a mirror 31, which may be positioned over the powder puff 30 when the device 10 is closed. A resilient tab 33 may be provided on the lid 12 to fasten (e.g., snap-fasten) on the body 11 of the box in the closed position.

In one embodiment of the invention, the substance P, which may be loose within the cup 14, is mixed with magnetizable particles 40 of a size that is large enough to prevent the magnetizable particles 40 from passing through a limiter element 19, for example, the mesh in a screen, under the effect of a magnetic field created by, for example, a solid permanent magnet 41 received in the powder puff 30.

In the exemplary embodiment described, the permanent magnet 41 may be rigid and based on rare earths, but alternatively, it could be replaced by any other type of magnet (e.g., a flexible magnet, a plurality of rigid and/or flexible magnets, and/or a set of magnetic particles 42 distributed within a powder puff as shown in FIG. 4). The particles 42 may be magnetic ab initio, or they may be magnetized after they have been placed within the powder puff 30.

The magnetic field generated by the powder puff 30 may be strong enough to act on the magnetizable particles 40 present within the substance P. In the exemplary embodiment shown in FIG. 1, the powder puff 30 may be placed above the limiter element 19 (e.g., a screen) when the device 10 is closed, and at least a fraction of the magnetizable particles 40 may be attracted against the inside face of the limiter element 19 during storage. When the particles 40 are attracted by the magnetic field generated by the powder puff 30, they may cause the substance P to move with them. For example, when the powder puff 30 is moved over the limiter element 19, the substance P present at the limiter element 19 may be removed by the user. When the powder puff 30 is moved away from the device 10, the magnetizable particles 40 may drop back into the cup 14, as shown in FIG. 2. Hence, this embodiment may provide a simple means for facilitating removal of a portion of substance P from the cup 14.

In order to somewhat immobilize the magnetizable particles 40 during transport, and/or for example, in order to prevent them from rattling, a removable permanent magnet 50 may be placed against the bottom of the device 10, as shown in FIG. 3, thereby generating a magnetic field that may tend to press the magnetizable particles 40 against the bottom of the cup 14. The magnetic field generated by the magnet 50 may be stronger than the field generated, for example, by the magnet 41 in the powder puff 30. Once the magnet 50 has been removed, the magnetic field created by the powder puff 30 may cause the magnetizable particles 40 to rise towards the limiter element 19, thereby transferring a portion of substance P towards the limiter element 19.

To make the magnetizable particles 40, it may be possible to use grains of a magnetizable material (e.g., iron or ferrites), or as shown in FIGS. 21 and 22, it may be possible to coat hollow spheres 362 (e.g., spheres comprising glass) with small magnetizable particles 361. The resulting magnetizable particles 40 may be covered with a layer of inert material 363, such as an acrylic resin. It may also be possible to coat other non-magnetic bodies (e.g., hollow or otherwise; e.g., fibers 370, for example wood fibers) in magnetizable particles 361. The resulting particles may be encapsulated in, for example, an inert resin 363.

The invention, however, is not limited to using magnetizable particles 40 mixed in with the substance P. It is possible to make the substance P sensitive to the action of a magnetic field. To do this, it is possible, for example, to coat the substance in grains 380 of magnetizable material, as shown in FIG. 23. It may also be possible to mix micro-particles of a material that is sensitive to the action of a magnetic field with the substance P so that the particles become intimately bonded with the substance P.

FIG. 5 is a schematic axial cross-section view of another exemplary embodiment of a device 10, which differs from that described with reference to FIG. 1 by the absence of magnetizable particles 40 mixed in with the substance P. The particles of substance P have been made magnetizable (e.g., by encapsulating grains 380 of magnetizable material). The size of the particles of magnetizable substance may be small enough to enable them to pass through, for example, the mesh of a screen.

As shown in FIG. 6, the device 10 may be fitted with, for example, a removable permanent magnet 50 for holding the substance P against the bottom of the cup 14 during transport. In another exemplary embodiment, the permanent magnet 41 of the powder puff 30 may be replaced, for example, by dispersed magnetic particles 42, as shown in FIG. 7.

Even in some exemplary embodiments where the limiter element that acts as an applicator element for substance P (e.g., the powder puff 30) is not itself magnetic, the substance P may be sensitive to the action of a magnetic field. One such embodiment may include a magnet fitted (e.g., removably in contact with or attached in a substantially non-removable or removable fashion) to the bottom of the device 10 serving, for example, to limit the tendency of the substance P to be blown out of the device 10 when the substance P is a relatively light substance (e.g., a powder).

It may also be possible to mix particles of the substance P that have been made magnetizable and that are of a size small enough to pass through the limiter element, where the limiter element includes, for example, a screen, with particles of a magnetizable material that have a larger size and that are substantially retained in the receptacle by the limiter element.

The invention, however, is not limited to a receptacle of any particular type, and the substance P may be disposed in a variety of receptacles, with the limiter element including configurations other than a screen.

For example, FIG. 8 is a schematic axial cross-section view of a device 60 including a receptacle 61 containing a substance P which may be mixed with, for example, magnetizable particles 40. The receptacle 61 may have an elongated shape along an axis X. The receptacle 61 may be partially closed on top by a screen 69 in the form of, for example, a basin, which may have a generally concave shape towards the outside. The top of the screen 69 may be connected to a cylindrical portion 62 for fixing it in the mouth of the receptacle 61. The cylindrical portion 62 may be terminated by a rim 63 bearing against the top edge of the body of the receptacle 61. The screen 69 may include perforations 64 of a size that is smaller than the size of the magnetizable particles 40, for example, so that the magnetizable particles 40 are retained inside the receptacle 61.

The device 60 may have an applicator element 65 which may be formed, for example, by a block of porous material fixed to a closure member 66 which may include a handle element. The closure element 66 may be provided with an outer skirt 67 including threading suitable for screwing onto a thread 68 of the receptacle 61. In another exemplary embodiment, the applicator element 65 may be a sintered element and/or any other optionally porous and/or deformable material suitable for retaining at least the substance P on its surface and for transferring the substance P by contact and/or friction to the surface to which the substance P is to be applied. The applicator element 65 could, for example, be of composite structure (e.g., it could have a flocking on its surface).

In the exemplary embodiment shown in FIG. 8, the applicator element 65 may include magnetic particles 42 within itself for generating a magnetic field that acts, for example, when the closure member 66 is in place on the receptacle 61, on the magnetizable particles 40 present inside the receptacle 61. The action of the magnetic field of the applicator element 65 on the magnetizable particles 40 may be effective when the receptacle 61 is upright, for example, if the magnetic field is strong enough, or only when the receptacle 61 is on its side or inverted, if, for example, the magnetic field is weaker.

In another exemplary embodiment (not shown), the applicator element may be capable of being detached from the closure member while the substance is being applied and/or in order to reload the applicator element with substance. The applicator element may also include an element that is independent of the closure member, thus making it possible, for example, to refill the applicator element with substance without it being necessary to position the closure member back onto the receptacle.

According to another exemplary embodiment, instead of using a screen having a concave shape, it is also possible to use a screen 80 fixed on a support 81 that may be mounted in the neck of the receptacle 61, as shown in FIG. 9. For example, the screen 80 may be heat-sealed onto an annular rim 82 of the support 81. It is also possible to form the limiter element from a composite structure (e.g., a structure including a superposition of a screen 80 and a perforated wall 90 having orifices 91, as shown in FIG. 10).

As shown in FIG. 11, the limiter element according to another aspect, may alternatively include a block 95 of, for example, a porous material (e.g., a foam material), superposed with a perforated wall 96 presenting perforations 97. The block 95 may be selected in such a manner as to present open cells that are of a size which is large enough to allow the substance P to pass therethrough. When the substance P is mixed with magnetizable particles 40 that are intended to be retained within the receptacle, for example, the size of the perforations 91 may be selected in such a manner as to prevent the particles 40 from passing through the perforations 91. It may also be possible for the size of the cells in the block 95 to be selected in such a manner as to prevent the particles 40 from passing therethrough.

In the exemplary embodiment shown in FIG. 8, the applicator element 65 contains magnetic particles 42. In another exemplary embodiment, as shown in FIG. 12, the closure member 66 may have a permanent magnet 98 which generates a magnetic field for acting on the magnetizable particles 40 present inside the receptacle and/or for acting on the substance P when the substance P is sensitive to the action of a magnetic field.

As shown in FIG. 13, in another aspect, device 100 includes a receptacle 101 containing substance P and an applicator 102. The applicator 102 may include an applicator element 103 and a handle member 104, which may also serve as a closure cap for the receptacle 101. The top portion of the receptacle 101 may include a threaded neck 105 onto which the closure cap 104 may be screwed. The applicator element 103 may be connected to the cap 104 by a relatively flexible stem 108. As shown in FIG. 13, the substance P may be mixed with magnetizable particles 40.

A limiter element 110 including, for example, a screen that may be generally finger-shaped may be fixed inside the neck 105 and may extend over a fraction of the height of and within the receptacle 101. In the exemplary embodiment shown, the inside diameter of the limiter element 110 may substantially correspond to the outside diameter of the applicator element 103. The limiter element 110 may be magnetic and/or magnetizable. Because the limiter element 110 may include a magnet, it may tend to attract the magnetizable particles 40 that may be present within the substance P. The substance P may be thus transported more easily from inside the receptacle 101 to the applicator element 103 that is situated inside the limiter element 110. The magnetizable particles 40 may be large enough to prevent them from passing through perforations in the limiter element 110. In another exemplary embodiment, the substance P may be magnetizable and may pass through perforations of the limiter element 110.

According to another aspect, FIG. 14 shows a device 120, which may include an applicator 130 having a magnetic applicator element 131 (e.g., substantially identical to the applicator 103 described with reference to the exemplary embodiment shown in FIG. 13) that may be connected via a stem 132 to a closure cap 133 screwed onto the neck 140 of the receptacle 141. The receptacle 141 may house a block 142 (e.g., of porous material) that may act as a wiper (e.g., presenting a passage that is substantially closed at rest when the applicator element 130 is absent from the receptacle 141). The block 142 may include a limiter element and may also remain open in the absence of the rod 132. The substance P may be magnetizable and, under the effect of the magnetic field, it may tend to adhere to the applicator element 131. The block 142 may serve to remove excess substance P from the applicator 130 as the applicator element 131 is being withdrawn from the receptacle 141. It will be understood that the applicator element 131 may be capable of attracting the substance P by means of the generated magnetic field. This may enable the applicator element 131 to be loaded more easily with substance P, for example, when only a small quantity of substance P remains inside the receptacle 141, with the receptacle 141 being shaken in such a manner as to disperse the substance inside the receptacle 141. For example, the substance P may be influenced by a magnetic field generated by the applicator element 131.

As mentioned previously herein, it would not go beyond the ambit of the present invention for the applicator element to have substantially no magnetic properties and for the device to include a magnet element and/or magnetizable element other than the applicator element. For example, the device could have a limiter element that is magnetic and/or magnetizable.

In another exemplary embodiment, the applicator element (e.g., a powder puff) shown in FIG. 7 is non-magnetic, and only the limiter element (e.g., a screen) is magnetic. The limiter element may attract a certain quantity of substance P (e.g., a magnetizable and/or magnetic substance) into contact therewith, and the substance P contacting the limiter element may be loaded onto the applicator element by, for example, wiping it over the limiter element. When the limiter element is magnetic, the applicator element may also be magnetic and/or magnetizable, and, for example, the applicator element may be capable of exerting a magnetic field on the substance P that is stronger than the magnetic field exerted by the limiter element so that the substance P may be taken from the limiter element by taking advantage of the effect of the magnetic field exerted by the applicator element.

In the exemplary embodiments described with reference to FIGS. 1 through 14, the limiter element is substantially permeable to the substance P and is stationary relative to the receptacle. There follows a description of exemplary embodiments, however, in which the limiter element may be suitable for conveying the substance that has been taken from inside the receptacle towards the outside and/or towards an applicator element.

The embodiment of FIGS. 15 and 16 could include one or more of the structural features of the device disclosed in U.S. Pat. No. 5,401,113. FIGS. 15 and 16 show a device 200 including a receptacle 210 and a rotary disk 201 carried by a support piece 211 which may be fixed onto the receptacle 210. The bottom region 202 of the disk 201 may pass through a housing 203 in the support piece 211 that may open out to the inside of the receptacle 210. The top region 204 of the disk may project above the support piece 211 and may serve to apply the substance P, for example, via transfer. The disk 201 may be secured to a hub 212 whose axial ends may be accessible to the user from the outside, thus enabling the user to turn the disk 201.

In the exemplary device 200 the rotary member 201 may be magnetic (e.g., because it has magnetic and/or magnetizable particles 42 therein) and the substance P may be mixed with magnetizable particles 40, such that the magnetizable particles 40, on being attracted by the rotary member 201, may serve to convey the substance P into contact therewith. The magnetizable particles 40 may be sized to prevent them from engaging in the small clearance that may exist between the rotary member 201 and the support piece 205, so that they drop back into the receptacle 210 during rotation of the rotary member 201.

In another exemplary embodiment, the substance P may be magnetic and/or magnetizable and may be attracted by the rotary member 201. The magnetic field exerted by the rotary member 201 on the substance P may be weak enough to enable the substance P to be transferred by friction onto the surface to which the substance P is to be applied.

The embodiment of FIG. 17 could include one or more of the structural features of the device disclosed in U.S. Pat. No. 5,836,320. FIG. 17 shows a device 300 including a receptacle 301 with a rotary limiter element 308 in its top portion which may be suitable for transferring substance P taken from within the receptacle 301 so as to bring the substance P into contact with, for example, an applicator element 305 that may be removably secured to the receptacle 301, and that may be secured to a handle element 306. When the handle element 306 is withdrawn, the limiter element 308 may prevent the substance P from leaving the receptacle 301.

The device 300 shown in FIG. 17 may include a limiter element 308 that may be magnetic and/or magnetizable, and the substance P may be magnetic and/or magnetizable, including, for example, at least in part, magnetic and/or magnetizable particles coated in the substance P. Because the limiter element 308 may be magnetic and/or magnetizable, it may be easier to load with substance P for transfer via friction and/or contact pressure to the applicator element 305. It will be understood that it would not go beyond the ambit of the present invention for the limiter element to also serve as an element for applying the substance P.

FIG. 18 shows another exemplary embodiment of a device. Device 350 may include a receptacle 351 in the form of, for example, a flexible tube, provided at one end with a limiter element 352 comprising a block of material that may be permeable to the substance. The limiter element 352 may be dome-shaped on the outside and may serve to apply the substance P directly. The limiter element 352 may include a sintered element or a porous element (e.g., a foam element). The substance P present inside the tube 351 may be magnetic and/or magnetizable, and may be capable of passing through pores in the limiter element 352 while the wall of the receptacle 351 is squeezed, thereby generating internal pressure. The limiter element 352 may be magnetic and/or magnetizable so that it may, for example, tend to maintain a certain quantity of substance P in contact therewith inside the receptacle 351, and/or so that it may be more easily refilled with substance P when the receptacle 351 is shaken, for example. Further, the receptacle 351 may be closed by a closure member 353.

In another exemplary embodiment, as shown in FIG. 19, the closure member 353 may house, for example, a permanent magnet 355, which may act on the substance P contained inside the receptacle 351 and/or within the limiter element 352, which need not be magnetic. In order to make the limiter element 352 magnetic, it may include magnetic particles incorporated therein, for example, and/or it may have magnetic particles 360 deposited (e.g., via spraying) on its inside face, as shown in FIG. 20.

Naturally the invention is not limited to the embodiments described above. For example, features belonging to different embodiments can be combined with one another.

The device according to some exemplary embodiments of the invention may be used to apply any cosmetic or care products, such as make-up, dermatological, or pharmaceutical compositions used for treating and/or changing the appearance of eyelashes, hair, skin, lips, or nails. However, in its broadest aspects, the present invention could be used to apply many other substances.

Furthermore, sizes of various structural parts and materials used to make the above-mentioned parts are illustrative and exemplary only, and one of ordinary skill in the art would recognize that these sizes and materials can be changed as necessary to produce different effects or desired characteristics.

It will be apparent to those skilled in the art that various modifications and variations can be made to the structure and methodology of the present invention. Thus, it should be understood that the invention is not limited to the examples discussed in the specification. Rather, the present invention is intended to cover modifications and variations.

What is claimed is:

1. A device comprising:
a receptacle;
a substance contained in the receptacle;
a plurality of particles contained in the receptacle, the plurality of particles comprising at least one of magnetizable particles mixed with the substance and magnetizable particles coated with the substance;
a limiter element configured to limit egress, from a portion of the device, of at least a portion of at least one of
the substance and
said at least one of magnetizable particles mixed with the substance and magnetizable particles coated with the substance; and
at least one of a magnetic element and a magnetizable element configured to generate a magnetic field for interacting with the particles in the receptacle.

2. The device of claim 1, wherein the limiter element is configured such that the limiter element is permeable to the substance.

3. The device of claim 2, wherein the limiter element comprises at least one member chosen from a screen member, a perforated wall member, a porous member, a sintered member, a felt member, a non-woven cloth member, a woven cloth member, and a brush member.

4. The device of claim 3, wherein the limiter element comprises a superposition of at least two members.

5. The device of claim 3, wherein the limiter element comprises a perforated wall lined with at least one of the porous member and the screen member.

6. The device of claim 1, further comprising an applicator element.

7. The device of claim 6, wherein the applicator element does not comprise the limiter element.

8. The device of claim 6, wherein the applicator element comprises said at least one of a magnetic element and a magnetizable element.

9. The device of claim 6, wherein the applicator element comprises at least one of an additional magnetic element and an additional magnetizable element.

10. The device of claim 8, wherein the applicator element houses a substantially solid magnet.

11. The device of claim 8, wherein the applicator element houses a flexible magnet.

12. The device of claim 8, wherein the applicator element comprises at least one of dispersed magnetic particles and dispersed magnetizable particles.

13. The device of claim 8, further comprising a handle element connected to the applicator element, the handle element being configured to substantially close the receptacle.

14. The device of claim 13, wherein the applicator element houses a magnet, the magnet being connected to the handle element.

15. The device of claim 1, wherein the limiter element is said at least one of a magnetic element and a magnetizable element.

16. The device of claim 1, wherein the limiter element comprises at least one of an additional magnetic element and an additional magnetizable element.

17. The device of claim 6, wherein the limiter element is at least one of magnetic and magnetizable, and the applicator element is substantially non-magnetic.

18. The device of claim 6, wherein the limiter element comprises a substantially planar screen and the applicator element comprises a powder puff.

19. The device of claim 6, wherein the limiter element comprises a substantially concave surface facing the applicator element.

20. The device of claim 6, wherein the limiter element comprises a substantially finger-shaped element.

21. The device of claim 1, wherein the limiter element comprises a porous element.

22. The device of claim 1, wherein at least a portion of the limiter element comprises an applicator element.

23. The device of claim 22, wherein the applicator element is connected to the receptacle.

24. The device of claim 23, wherein the applicator element is connected to the receptacle so as to substantially preclude disconnection therefrom.

25. The device of claim 23, further comprising a closure member for closing the receptacle.

26. The device of claim 25, wherein the closure member comprises said at least one of a magnetic element and a magnetizable element.

27. The device of claim 25, wherein the closure member comprises at least one of an additional magnetic element and an additional magnetizable element.

28. The device of claim 23, wherein the applicator element comprises said at least one of a magnetic element and a magnetizable element.

29. The device of claim 23, wherein the applicator element comprises at least one of an additional magnetic element and an additional magnetizable element.

30. The device of claim 28, wherein the applicator element comprises at least one of magnetic particles and magnetizable particles.

31. The device of claim 1, wherein the limiter element comprises a rotary element.

32. The device of claim 31, wherein the limiter element comprises an outside zone configured to apply the substance and an inside zone configured to be loaded with the substance.

33. The device of claim 31, further comprising an applicator element.

34. The device of claim 33, wherein the applicator element does not comprise the limiter element.

35. The device of claim 33, wherein the limiter element is configured to transfer the substance from the receptacle to the applicator element.

36. The device of claim 31, wherein the limiter element comprises said at least one of a magnetic element and a magnetizable element.

37. The device of claim 31, wherein the limiter element comprises at least one of an additional magnetic element and an additional magnetizable element.

38. The device of claim 6, wherein the applicator element comprises at least one of a porous element, a sintered element, a felt element, a non-woven cloth element, bristles, a woven cloth element, and flocking.

39. The device of claim 1, further comprising at least one removable magnet configured to generate a magnetic field that opposes egress of at least some of the particles from the receptacle.

40. The device of claim 39, wherein the at least one magnetic element comprises the at least one removable magnet.

41. The device of claim 39, wherein the at least one magnetic element does not comprise the removable magnet.

42. The device of claim 41, wherein the magnetic field that opposes egress of at least some of the particles from the receptacle is stronger than the magnetic field for interacting with the particles in the receptacle.

43. The device of claim 39, wherein the receptacle comprises a bottom wall having an outside face and the removable magnet is configured to be fixed on the outside face.

44. The device of claim 1, wherein at least a portion of the particles comprises magnetizable particles coated with at least one of a cosmetic product and a care product.

45. The device of claim 1, wherein at least a portion of the particles comprises said magnetizable particles mixed with the substance.

46. The device of claim 45, wherein the limiter element comprises at least one passage defining a dimension configured to enable egress of the substance from the receptacle and configured to substantially prevent egress of the magnetizable particles from the receptacle.

47. The device of claim 45, wherein the substance comprises a binder configured to encourage the substance to adhere to the magnetizable particles.

48. The device of claim 45, wherein at least a portion of the magnetizable particles comprises substantially non-magnetic bodies having grains of magnetizable material fixed on the surface of the substantially non-magnetic bodies.

49. The device of claim 48, wherein the non-magnetic bodies are chosen from at least one of fibers, wood fibers, beads, and hollow glass beads.

50. The device of claim 1, wherein at least a portion of the substance comprises a powder.

51. The device of claim 1, wherein at least a portion of the substance comprises a liquid.

52. The device of claim 1, wherein the receptacle comprises substantially rigid bottom and side walls.

53. The device of claim 1, wherein the substance comprises at least one of a cosmetic product and a care product.

54. The device of claim 53, wherein the substance comprises a make-up product.

55. The device of claim 6, wherein the applicator element is configured to apply at least the substance.

56. A method of applying a product comprising:
providing the device of claim 6;
loading the applicator element with at least the substance; and
placing the applicator element in contact with at least one of skin, hair, a finger nail, a toe nail, eye lashes, and eye brows so as to apply at least the substance thereto.

57. The method of claim 56, wherein the product comprises at least one of a cosmetic product and a care product.

58. The method of claim 57, wherein the product comprises a make-up product.

59. A method of loading an applicator element with at least substance, the method comprising:
providing the device of claim 6; and
moving at least a portion of the substance toward the applicator element with the at least one of a magnetic element and a magnetizable element so as to encourage loading of the applicator element with substance.

60. A method for loading an applicator element with at least substance, the method comprising:
moving the substance via a magnetic field in order to encourage the applicator element to be loaded with at least the substance.

61. A device comprising:
a receptacle;
a substance contained in the receptacle;
a plurality of particles contained in the receptacle, the plurality of particles comprising at least one of magnetizable particles mixed with the substance and magnetizable particles coated with the substance; and
an applicator element configured to attract at least a portion of one of the magnetizable particles mixed with the substance and the magnetizable particles coated with the substance.

62. The device of claim 61, wherein the applicator element comprises at least one of a magnetic element and a magnetizable element configured to attract at least a portion of the particles in the receptacle.

63. The device of claim 61, further comprising a limiter element configured to limit egress, from a portion of the device, of at least a portion of at least one of the substance and said at least one of magnetizable particles mixed with the substance and magnetizable particles coated with the substance.

64. The device of claim 63, wherein the limiter element is configured such that the limiter element is permeable to the substance.

65. The device of claim 64, wherein the limiter element comprises at least one member chosen from a screen member, a perforated wall member, a porous member, a sintered member, a felt member, a non-woven cloth member, a woven cloth member, and a brush member.

66. The device of claim 65, wherein the limiter element comprises a superposition of at least two members.

67. The device of claim 65, wherein the limiter element comprises a perforated wall lined with at least one of the porous member and the screen member.

68. The device of claim 63, wherein the applicator element does not comprise the limiter element.

69. The device of claim 61, wherein the applicator element houses a substantially solid magnet.

70. The device of claim 61, wherein the applicator element houses a flexible magnet.

71. The device of claim 62, wherein the applicator element comprises at least one of dispersed magnetic particles and dispersed magnetizable particles.

72. The device of claim 61, further comprising a handle element connected to the applicator element, the handle element being configured to substantially close the receptacle.

73. The device of claim 72, wherein the applicator element houses a magnet, the magnet being connected to the handle element.

74. The device of claim 63, wherein the limiter element comprises at least one of a magnetic element and a magnetizable element.

75. The device of claim 63, wherein the limiter element is at least one of magnetic and magnetizable.

76. The device of claim 63, wherein the limiter element comprises a substantially planar screen and the applicator element comprises a powder puff.

77. The device of claim 63, wherein the limiter element comprises a substantially concave surface facing the applicator element.

78. The device of claim 63, wherein the limiter element comprises a substantially finger-shaped element.

79. The device of claim 63, wherein the limiter element comprises a porous element.

80. The device of claim 63, wherein at least a portion of the limiter element comprises the applicator element.

81. The device of claim 80, wherein the applicator element is connected to the receptacle.

82. The device of claim 81, wherein the applicator element is connected to the receptacle so as to substantially preclude disconnection therefrom.

83. The device of claim 81, further comprising a closure member for closing the receptacle.

84. The device of claim 83, wherein the closure member comprises at least one of a magnetic element and a magnetizable element.

85. The device of claim 83, wherein the closure member is configured to be removably connected to the receptacle.

86. The device of claim 81, wherein the applicator element comprises at least one of a magnetic element and a magnetizable element.

87. The device of claim 63, wherein the applicator element comprises at least one of an additional magnetic element and an additional magnetizable element.

88. The device of claim 87, wherein the limiter element is configured to enable egress of the substance from the receptacle and to substantially prevent egress of the particles from the receptacle.

89. The device of claim 63, wherein the limiter element comprises a rotary element.

90. The device of claim 89, wherein the limiter element comprises an outside zone configured to apply the substance and an inside zone configured to be loaded with the substance.

91. The device of claim 89, wherein the applicator element comprises at least a portion of the limiter element.

92. The device of claim 89, wherein the applicator element does not comprise the limiter element.

93. The device of claim 89, wherein the limiter element is configured to transfer the substance from the receptacle to the applicator element.

94. The device of claim 89, wherein the limiter element comprises at least one of a magnetic element and a magnetizable element.

95. The device of claim 89, wherein the limiter element comprises at least one of an additional magnetic element and an additional magnetizable element.

96. The device of claim 61, wherein the applicator element comprises at least one of a porous element, a sintered element, a felt element, a non-woven cloth element, bristles, a woven cloth element, and flocking.

97. The device of claim 61, further comprising at least one removable magnet configured to generate a magnetic field that opposes egress of at least some of the particles from the receptacle.

98. The device of claim 97, wherein the at least one removable magnet is connected to the receptacle.

99. The device of claim 97, further comprising at least one magnetic element configured to generate a magnetic field for interacting with the particles in the receptacle, wherein the at least one magnetic element does not comprise the removable magnet.

100. The device of claim 99, wherein the magnetic field that opposes egress of at least some of the particles from the receptacle is stronger than the magnetic field for interacting with the particles in the receptacle.

101. The device of claim 97, wherein the receptacle comprises a bottom wall having an outside face and the removable magnet is configured to be fixed on the outside face.

102. The device of claim 61, wherein at least a portion of the particles comprises magnetizable particles coated with at least one of a cosmetic product and a care product.

103. The device of claim 61, wherein at least a portion of the particles comprises said magnetizable particles mixed with the substance.

104. The device of claim 63, wherein the limiter element comprises at least one passage defining a dimension configured to enable egress of the substance from the receptacle and configured to substantially prevent egress of the magnetizable particles from the receptacle.

105. The device of claim 103, wherein the substance comprises a binder configured to encourage the substance to adhere to the magnetizable particles.

106. The device of claim 103, wherein at least a portion of the magnetizable particles comprises substantially non-magnetic bodies having grains of magnetizable material fixed on the surface of the substantially non-magnetic bodies.

107. The device of claim 106, wherein the non-magnetic bodies are chosen from at least one of fibers, wood fibers, beads, and hollow glass beads.

108. The device of claim 61, wherein at least a portion of the substance comprises a powder.

109. The device of claim 61, wherein at least a portion of the substance comprises a liquid.

110. The device of claim 61, wherein the receptacle comprises substantially rigid bottom and side walls.

111. The device of claim 61, wherein the substance comprises at least one of a cosmetic product and a care product.

112. The device of claim 111, wherein the substance comprises a make-up product.

113. The device of claim 61, wherein the applicator element is configured to apply at least the substance.

114. A method of applying a product comprising:
providing the device of claim 61;
loading the applicator element with at least the substance; and
placing the applicator element in contact with at least one of skin, hair, a finger nail, a toe nail, eye lashes, and eye brows so as to apply at least the substance thereto.

115. The method of claim 114, wherein the product comprises at least one of a cosmetic product and a care product.

116. The method of claim 115, wherein the product comprises a make-up product.

117. A method of loading an applicator element with at least substance, the method comprising:
providing the device of claim 61; and
moving at least a portion of the substance toward the applicator element with the at least one of a magnetic element and a magnetizable element so as to encourage loading of the applicator element with substance.
